(19) United States
(12) Patent Application Publication
(10) Pub. No.: US 2005/0244792 A1
(43) Pub. Date: Nov. 3, 2005

(54) Ultrasonic tooth whitening system

(76) Inventors: Anthony J. Verdi, Flemington, NJ (US); William R. Wroga, Woodstock, IL (US)

Correspondence Address: WOLF BIOENGINEERING INC., 1417 KIRKWALL COURT, BARRINGTON, IL, 60010, US

(21) Appl. No.: 10/837,154

(22) Filed: May 3, 2004

(51) Int. Cl. A61C 5/00

(52) U.S. Cl. 433/215

(57) ABSTRACT

A tray for containing a tooth whitening gel such as hydrogen peroxide in various forms, similar active agents and agents of a proprietary nature is equipped with a single, external ultrasonic transducer. A parabolic reflector directs the ultrasound to the teeth. The ultrasound drives the whitening gel into the tooth enamel and thereby enhances the whitening action. The tray is attached to an adjustable ultrasonic frequency generator, which allows the practitioner to adjust the frequency of the ultrasound to obtain the optimum whitening. This ultrasonic system accelerates the tooth whitening process while simplifying, reducing the cost, and increasing the safety and patient comfort compared to current systems that employ ultraviolet light.

### CROSS REFERENCE TO RELATED APPLICATIONS

None

### STATEMENT REGARDING FED SPONSORED R & D

No federal funds were used in the development of this invention.

### REFERENCE TO SEQUENCE LISTING, A TABLE OR A COMPUTER PROGRAM LISTING APPENDIX

None

### BACKGROUND OF THE INVENTION

Exposing the teeth to a whitening agent such as hydrogen peroxide in various forms, other similar agents, and active agents of a proprietary nature can whiten teeth. The whitening agent can be applied to the teeth in a variety of ways. For example, the agent can be placed into a tray, which is then placed around the teeth. U.S. Pat. No. 3,527,219, U.S. Pat. No. 4,138,814 and U.S. Pat. No. 5,165,424 show trays for treating teeth with fluoride gels. U.S. Pat. No. 5,009,885, U.S. Pat. No. 5,032,178 and U.S. Pat. No. 5,076,791 are directed to cleaning/whitening gels.

Additional means to enhance the whitening of the teeth can be added to the process. Ultraviolet light has been employed to enhance the action of the whitening agent, but this necessitates the use of sun blocks and eye protection for the patient and can cause damage to the skin, eyes and mucous membranes. Also, the patient cannot move his or her head while the light is on which can be as long as 2 hours. U.S. Pat. No. 3,380,446 discusses using ultrasound to enhance the whitening. U.S. Pat. No. 4,237,574 suggests using ultrasound to activate bristles in a tray to clean the teeth. U.S. Pat. No. 4,116,239 describes a hand held ultrasonic tool that blows oxygen at the teeth to enhance cleaning/whitening.

### BRIEF SUMMARY OF THE INVENTION

This invention is a system for whitening teeth, which employs variable frequency ultrasonic energy to drive a whitening gel, hydrogen peroxide in various forms, other similar agents and active agents of a proprietary nature, into and around the enamel of the teeth. This action accelerates the whitening compared to methods that do not employ ultrasonics. This method also avoids the risk of the damage to skin, eyes and mucous membranes and the need for eye wear and sunblock when an ultraviolet light is employed in other approaches. The patient is also free to move his head during the treatment. Also, this invention allows the practitioner to adjust the frequency of the ultrasound for individual cases to obtain optimum performance. Systems that employ light do not allow adjustment of the light frequency.

The first element of the system consists of a tray for containing the whitening gel that surrounds the teeth and is equipped with a single external transducer to produce the ultrasound. In the prior art, U.S. Pat. No. 3,380,446 describes a tray for cleaning or whitening teeth that contains a plurality of ultrasonic transducers. U.S. Pat. No. 4,237,574 mentions using ultrasonics to agitate bristles in a tooth cleaning tray, but gives no details and makes no ultrasound claims. The present invention employs only a single transducer, which greatly simplifies the construction and cost of the tray. Also, U.S. Pat. No. 3,380,446 claims the transducer positions adjacent to the inside surface of the tray. This location is inside the patient's mouth resulting in high voltage wires in the patient's mouth; a dangerous arrangement. In the present invention, a single transducer is located outside of the user's mouth thereby reducing the risk of electric shock. A parabolic reflector directs the ultrasound toward the teeth.

The second element of the present whitening system invention is an electronic power supply connected by wiring to the tray transducer to generate the ultrasound. The adjustable frequency range of the power supply is 10 kilohertz to 300 megahertz.

### BRIEF DESCRIPTION OF THE DRAWINGS

FIG. 1 is a top view of the tray.

FIG. 2 is a central cross section A-A of the tray.

FIG. 3 is a side view of the transducer, clip and positioner.

FIG. 4 is a prospective view of the tray.

FIG. 5 is a view of the ultrasonic power supply.

### DETAILED DESCRIPTION

This invention is a tray for containing a whitening gel that surrounds the teeth to be whitened, which is equipped with a single external transducer for generating ultrasound, which is transmitted into the whitening gel. The ultrasound causes mixing of the whitening gel, drives the whitening gel into the tooth surface, and refreshes the gel at the tooth surface. These effects result in a faster, more complete whitening of the teeth. The tray is designed to surround both the upper and lower teeth simultaneously.

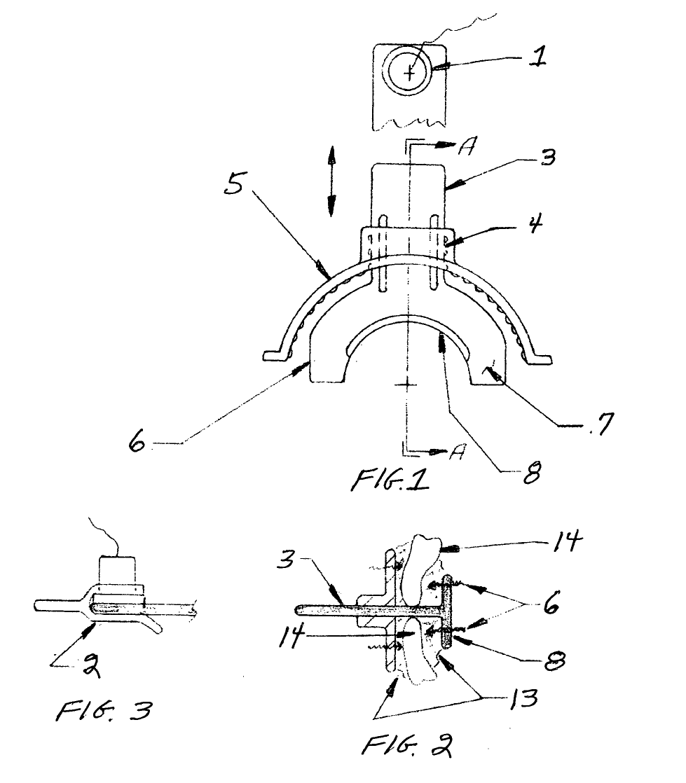

FIG. 1 is a top view of the tray. A ultrasonic transducer 1 is mounted by a clip to a positioner 3 on the whitening gel tray 4 which is equipped with a front parabolic reflector 5 and a rear parabolic reflector 6 which also serves as a bite plane 7 and tongue shield 8. The positioner 3 allows the practitioner to place the tray into the proper position in the mouth, and it conducts the ultrasound from the transducer 1 to the front parabolic reflector 5. The front parabolic reflector 5 distributes and transmits the ultrasound into the whitening gel that surrounds the teeth. The rear parabolic reflector 6 reflects the ultrasound back into the whitening gel, forms a bite plane 7 for the teeth to rest on, and forms a tongue shield 8 to protect the tongue from the effects of the gel. The tray is fabricated from inexpensive materials and is a sterile, disposable, one-time use item. The transducer is reused and is easily clipped to the tray.

FIG. 2 is a cross sectional drawing of the tray. The teeth 14 are surrounded by the whitening gel 13 which is held in place by the front parabolic reflector and the rear parabolic reflector 6 which transmit the ultrasound into the gel.

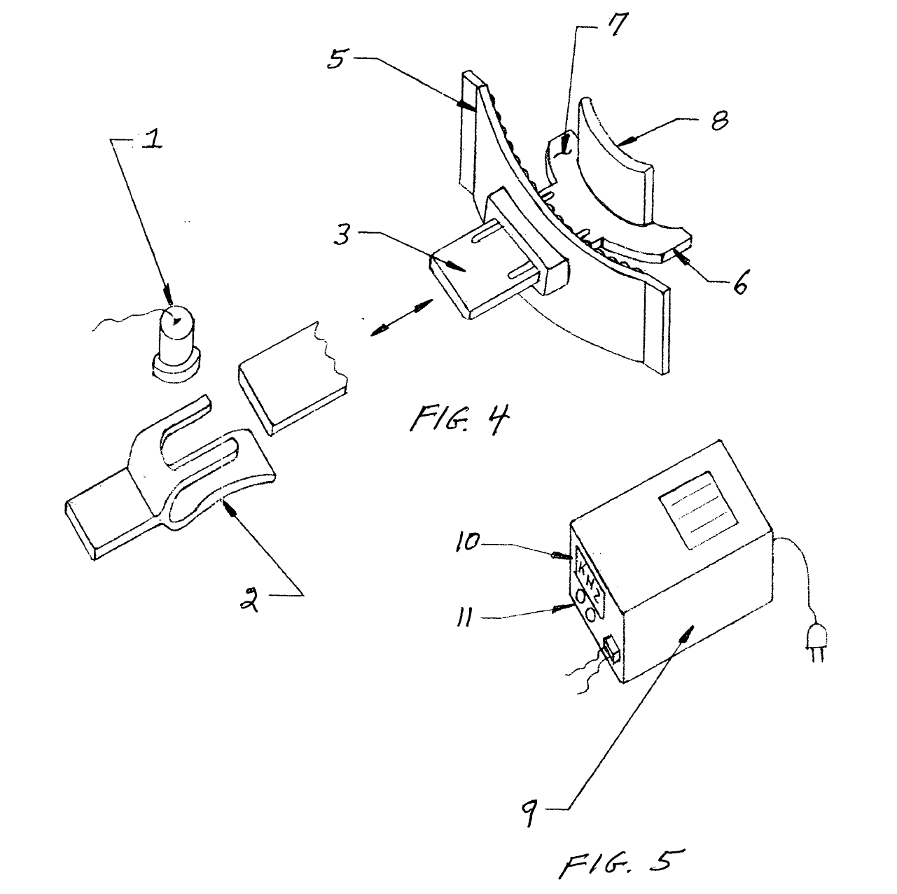

FIG. 3 shows the clip 2 which holds the transducer to the positioner.

FIG. 4 is a perspective view of the tray that shows the clip 2 removed from the transducer 1 and positioner 3.

FIG. 5 is a view of the ultrasonic power supply. The power source 9 is equipped with power frequency readout 10, a frequency adjustment 11, and power leads 12 that connect to the transducer 1. The output of the power source is in the frequency range of 10 kilohertz to 300 megahertz and can be adjusted by the frequency adjustment 11, and/or can sweep back and forth between a high and low frequency setting. This allows the practitioner to adjust the frequency of the ultrasound for individual cases to obtain the optimum treatment in terms of whitening and time of treatment.

1. A tray for containing a tooth whitening gel that is equipped with a single ultrasonic transducer.

2. The tray of claim 1 where the ultrasonic transducer is external to the user's mouth.

3. The tray of claim 1 equipped with a positioner.

4. The tray of claim 3 with the ultrasonic transducer clipped to the positioner.

5. The tray of claim 1 equipped with a front reflector.

6. The tray of claim 1 equipped with a back reflector.

7. The tray of claim 1 equipped with both a front and back reflector.

8. The tray of claims 6 or 7 with a back reflector forming a bite plane.

9. The tray of claims 6 or 7 with a back reflector forming a tongue shield.

10. The tray of claims 6 or 7 with the back reflector forming both a bite plane and a tongue shield.

11. The tray of claim 4 with a front reflector, and a back reflector forming a bite plane and tongue shield.

12. An ultrasonic power supply with an adjustable frequency range of 10 kilohertz to 300 megahertz.

13. The ultrasonic power supply of claim 12 which sweeps back and forth between a high and low frequency setting.
